(19) United States
(12) Patent Application Publication
(10) Pub. No.: US 2016/0155319 A1
(43) Pub. Date: Jun. 2, 2016

(54) System And Method For Take-over Protection For A Security System

(71) Applicant: Honeywell International Inc., Morristown, NJ (US)

(72) Inventors: Kenneth G. Eskildsen, Great Neck, NY (US); Mark Douglas Okeefe, San Diego, CA (US); Doug Marshall, Sugarland, TX (US)

(21) Appl. No.: 14/557,733

(22) Filed: Dec. 2, 2014

(51) Int. Cl. G08B 25/14; G08B 25/10; G08B 25/00

(52) U.S. Cl. CPC G08B 25/14; G08B 25/003; G08B 25/008; G08B 25/10

(57) ABSTRACT

A secure communications and monitoring system includes a control unit and a plurality of modules distributed in a region to be monitored. The control unit has an assigned identifier. When a module is installed in the system, the control unit transmits the identifier to the module which stores it. Before a module communicates with the control unit, the identifier is requested from the control unit. The identifier received from the control unit is compared to the stored identifier. The module will only communicate with the control unit where the identifier received at the module corresponds to the identifier stored at the module.

### FIELD

The application pertains to regional monitoring or control systems. More particularly, the application pertains to security or ambient condition monitoring systems wherein system components, detectors or control elements, limit their communications to known, or pre-determined system control units.

### BACKGROUND

Security dealers provide security systems to protect people's lives and property. There are various segments to the security business market, ranging from high end installations to basic, low-cost solutions. The basic, low-cost solution is usually offered to the consumer at a cost lower than the cost of the security equipment, with the expectation that the cost will be recovered via the monthly monitoring fee. Problems arise when a competing security dealer offers the consumer a lower monthly monitoring fee and “takes over” the installed security equipment.

“Taking over” a security system saves the competitor the time and expense of installing the security system. The process of “taking over” a security system involves removing the existing control panel, installing a new control panel, and configuring the control panel to accept signals from the existing security sensors. Hence, the savings are realized by the reuse of the existing sensors that were provided by the original security dealer.

### BRIEF DESCRIPTION OF THE DRAWINGS

FIG. 1 is a block diagram of a system in accordance herewith; and

FIG. 2 is a flow diagram in accordance herewith.

### DETAILED DESCRIPTION

While disclosed embodiments can take many different forms, specific embodiments hereof are shown in the drawings and will be described herein in detail with the understanding that the present disclosure is to be considered as an exemplification of the principles hereof, as well as the best mode of practicing same, and is not intended to limit the claims hereof to the specific embodiment illustrated.

In embodiments hereof, the problem is solved by pairing members of a plurality of system modules, such as security sensors, control elements or ambient condition detectors with a system control panel, or system control circuits. In a disclosed embodiment, the modules, for example, the sensors, control elements or detectors, without limitation, will only communicate with the system control circuits provided by the security dealer that installed the entire system.

Should a competing dealer try to “take over” the system by removing the control circuits, or, panel, the existing modules, whether they be implemented as sensors, ambient condition detectors or control elements will not communicate with the new control system, or, panel. Therefore, the entire system (panel and modules) will need to be replaced to take over the system.

In one aspect hereof, only an authorized user can remove a sensor, detector, or, peripheral from the security system and reuse it with a different security system.

An authorized user can be the dealer, installer or other person assigned by the dealer (perhaps the end user.) There are many ways to determine if a user is “authorized” such as the use of an authorized user code, biometric identifier, password, etc. Once the user is authenticated the removal and reuse of the respective module is permitted.

In a disclosed embodiment, two-way RF modules are coupled to an integral RF modular network identifier (ID). The network ID is derived from, for example, a MAC address that is stored in the control panel. This MAC address is unique to the control panel and in the domain of MAC addresses. Other identifiers can be used without departing from the spirit and scope hereof.

When a module is enrolled into the control panel, the control panel provides the network ID to that module. The network ID is stored in non-volatile memory in the module. Whenever the module communicates with the control panel, it verifies the network ID of the panel. If the received ID does not match the pre-stored ID, the module will cease communications with that panel.

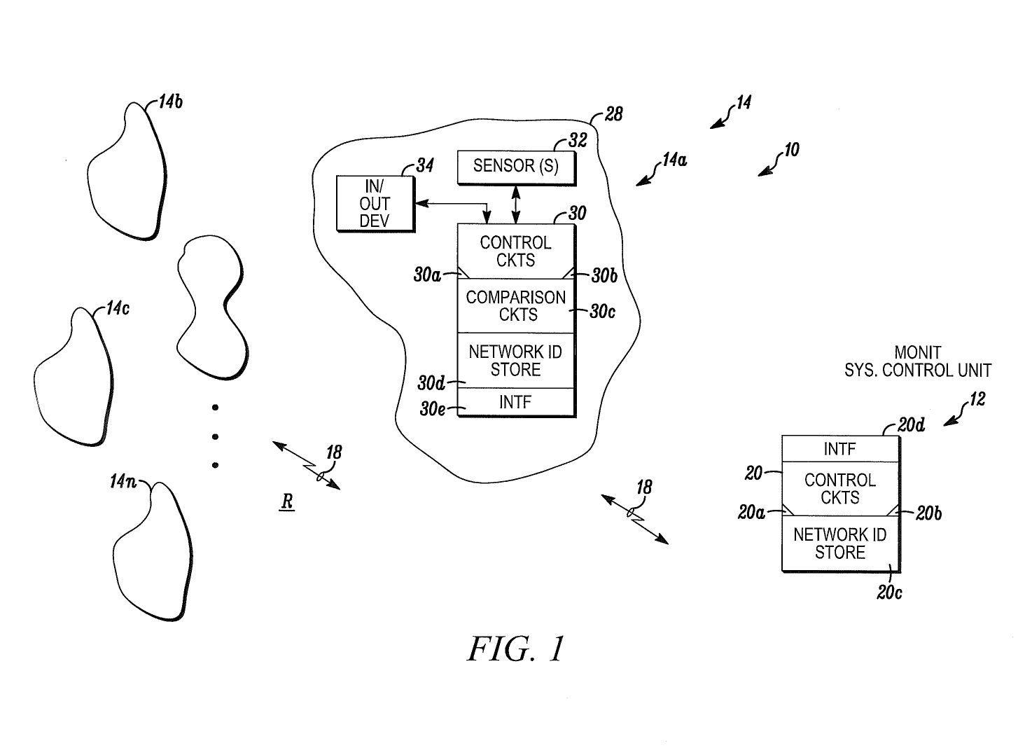

FIG. 1 illustrates a monitoring system 10 which has a local control unit 12. A plurality of modules 14 can be in bidirectional wired, or, wireless RF communications with the control unit 12. Members of the plurality 14, such as 14a, 14b . . . 14n can be installed throughout a region R of interest. Members of the plurality 14 can include, without limitation, motion detectors, position detectors, glass break detectors, smoke detectors, flame detectors, gas detectors, thermal detectors, door access control modules, and authorizing modules.

Control unit 12, and members 14a, 14b . . . 14n of the plurality of modules 14 can be in bidirectional communication as would be understood by those of skill in the art. The communications medium, 18, can be wired or wireless, without limitation.

Control unit, or panel, 12 can include control circuits 20 which can be implemented, at least in part with one or more programmable processors 20a and associated, executable control software, or instructions 20b.

A unique network identifier 20c can be assigned to system 10 and stored in non-volatile storage 20c. An input/output wired or wireless interface 20d can also be coupled to the control circuits 20.

Module 14a is representative of the members of the plurality 14. A discussion of module 14a will also suffice for a discussion of the remaining members of the plurality 14.

Module 14a includes a housing 28 which can be mounted to a wall ceiling, floor or the like without limitation depending on the characteristic thereof. The particular mounting arrangement is not a limitation hereof.

Housing 28 can carry control circuits 30 which can be implemented at least in part with one or more programmable processors 30a in combination with pre-stored, executable control instructions 30b. The control circuits 30 are coupled to comparison circuits 30c, and to a non-volatile network identification storage unit 30d. The control circuits 30 are also coupled to a wired, or wireless communications interface 30e to implement bidirectional communications with the unit 12 via medium 18.

Control circuits 30 are also coupled to one or more sensors 32 and/or one or more input/output devices 34. The devices 32, 34 can be selected from a class which includes at least motion detectors, position detectors, glass break detectors, smoke detectors, flame detectors, gas detectors, thermal detectors, door access control modules, solenoid modules, and authorizing modules, all without limitation.

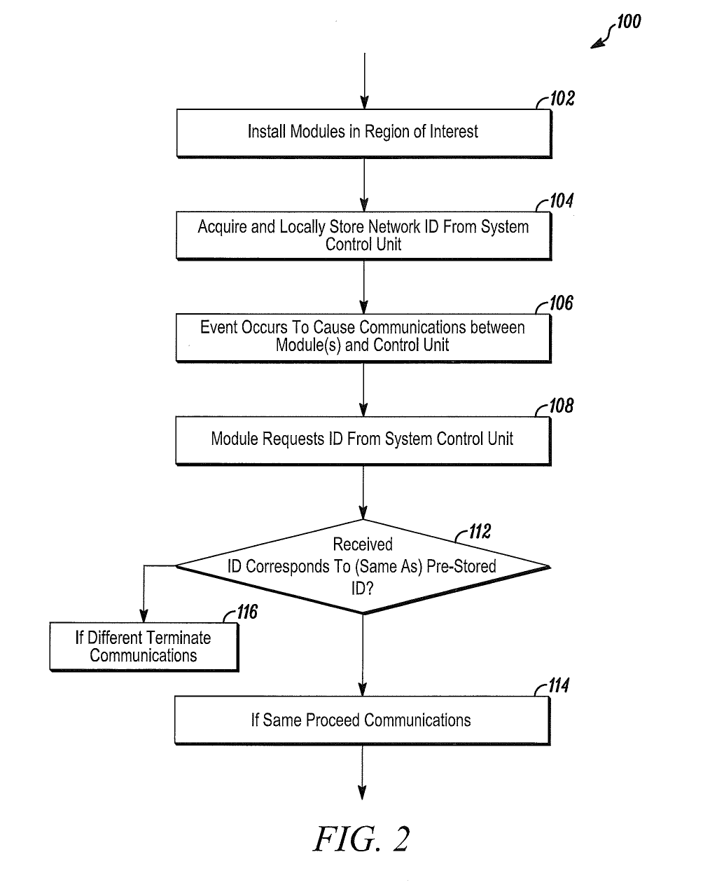

FIG. 2 illustrates aspects of a method 100 of operating system 10. The various modules 14 can be initially installed in region R as required, as at 102. The following method is representative of processing in connection with a group of modules 14 in an initial system installation, or replacement of a single module after installation.

Each of the modules 14 acquires and locally stores a network identifier, obtained from control unit 12, and stored locally at unit 30c, as at 104. When an event occurs that causes communications to occur between one more members of the plurality 14 and the control unit 12, as at 106, each respective module requests that the control unit 12 transmit a copy of the system identifier, stored, for example at storage element 20c, as at 108.

The system identifier received at the module 14a, from the control unit 12 is compared to the pre-stored identifier, at 30d using comparison circuits 30c, as at 112. If the pre-stored identifier from unit 30c corresponds to, or is the same as the received identifier, as at 112, the communications proceed as at 114. If not, communications are either not initiated or terminated as at 116. It will be understood that neither the details as to how the pre-stored identifier is represented at the unit 14a nor the exact details of the comparison with the pre-stored identifier and the received identifier are limitations hereof.

As those of skill in the art will understand, there will be various ways for the installer to manage the network ID so that sensors can be removed, replaced or repurposed. However, this capability will only be available via secure communications by the dealer that installed the equipment.

Alternate methods may achieve the goal of pairing a module, or, sensor with a security system and only allowing authorized users to repurpose a sensor. Such other systems, or, methods that achieve the same result come within the spirit and scope hereof.

In summary the sensors, or detectors, are manufactured in a default state. This state enables the sensor to be enrolled with any compatible security system. Once the sensor has been enrolled with a panel it is no longer in the default state and it will only work with the panel that it has been enrolled with. To repurpose, that is to enroll the sensor with a different panel it will need to be reset to the default state. Only authorized users can reset the sensors into the default state.

During implementation, for example, during the first 24 hours after enrollment, the enrolled sensors can be defaulted at the system control panel by anyone, not just an authorized user. This feature provides a way to deal with enrollment mistakes; when a sensor is enrolled with the wrong control panel.

Panel replacement, if the control panel malfunctions and needs to be replaced, a process is available for an authorized user to replace the control panel and all of the sensors will change their allegiance to the new panel.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. A method comprising:
establishing a selected system, and, providing a plurality of modules in the system which communicate with a least a selected member of the plurality;
providing a selected member identifier which is made available to at least some of the members of the plurality;
storing the selected member identifier;
requesting that the selected member communicate the selected member identifier to at least one other member of the plurality;
receiving the selected member identifier and comparing the received identifier with a pre-stored identifier; and
initiating communications with the selected member only if the selected member identifier matches the stored identifier.

2. A method as in claim 1 which includes providing a monitoring system control panel as the selected member.

3. A method as in claim 1 which includes providing a plurality of ambient condition detectors, and evaluating the selected member identifier at the detectors before initiating communications with the selected member.

4. A method as in claim 3 which includes providing a monitoring system control panel as the selected member.

5. A method as in claim 1 which includes selecting modules from a class which includes at least motion detectors, position detectors, glass break detectors, smoke detectors, flame detectors, gas detectors, thermal detectors, door access control modules, and authorizing modules.

6. A method as in claim 1 which includes providing non-volatile storage at the members of the plurality and wherein storing includes storing the selected member identifier in the non-volatile storage at respective members of the plurality.

7. A method as in claim 6 which includes providing wireless communications between at least some members of the plurality and the selected member.

8. A method as in claim 7 which includes selecting modules from a class which includes at least motion detectors, position detectors, glass break detectors, smoke detectors, flame detectors, gas detectors, thermal detectors, door access control modules, and authorizing modules.

9. A method as in claim 8 which includes providing wireless transceivers in at least some of the modules, and in the selected member.

10. An apparatus comprising:
a communications system having a plurality of modules which communicate with at least a selected system module;
a predetermined identifier associated with the selected module;
a storage element at each of the modules; and
circuitry at the selected module to send the identifier to each of the other modules for storage in the respective storage element, wherein each module requests the identifier from the selected module prior to communicating with selected module, and, including circuitry at each module to compare a received, requested identifier, to an identifier pre-stored in the element, wherein communications with the selected module are not initiated where a received identifier differs from the identifier stored in the respective module.

11. An apparatus as in claim 10 wherein members of the plurality of modules are selected from a class that includes, at least, motion detectors, position detectors, glass break detectors, smoke detectors, flame detectors, gas detectors, thermal detectors, door access control modules, and authorizing modules.

12. An apparatus as in claim 11 wherein the selected module comprises a system control unit.

13. An apparatus as in claim 12 where the system comprises a regional monitoring system and the identifier is associated with the system control unit.

14. An apparatus as in claim 13 wherein the modules of the system will not communicate with a control unit which has an identifier different from the stored identifier at a respective module.

15. An apparatus as in claim 12 where the system is selected from a class which includes at least a heating ventilating and air conditioning system, a fire detection system, a gas detection system, or a security monitoring system.

16. An apparatus as in claim 15 where at least some of the modules communicate wirelessly with the system control unit.

17. A secure communications and monitoring system comprises a control unit and a plurality of modules in wireless communication with one another; wherein the control unit has an assigned identifier, and, when a module is installed in the system, the control unit transmits the identifier to the module which stores it; before a module communicates with the control unit, the identifier is requested from the control unit by the module, and, the identifier received from the control unit is compared to the stored identifier at the module, wherein, the module will only communicate with the control unit where the identifier received at the module corresponds to the identifier stored at the module.

18. A system as in claim 17 which includes comparison circuitry to compare the identifier stored at the module to an identifier received from the control unit.

19. A method comprising:
providing a plurality of detectors where the members of the plurality exhibit a default state and such detectors can be enrolled with a compatible security system;
wherein once a detector has been enrolled with a security system, it exhibits a different, non-default state such that it only operates with the respective security system with which it has been enrolled; and
wherein enrolling the detector with a different control panel requires resetting the respective detector to the default state.

20. A method as in claim 19 including providing at least one authorized user who can reset detectors to the default state.
